(19) United States
(12) Patent Application Publication
(10) Pub. No.: US 2024/0309150 A1
(43) Pub. Date: Sep. 19, 2024

(54) POLYESTER POLYMER

(71) Applicant: PPG Industries Ohio, Inc., Cleveland, OH (US)

(72) Inventors: Paul Hubert Lamers, Allison Park, PA (US); Christopher A. Verardi, Pittsburgh, PA (US); Karen A. Morow, Verona, PA (US); Chad Alan Landis, Oakmont, PA (US); Yaqi Wo, Allison Park, PA (US); Mitchell R. Stibbard, Sewickley, PA (US); Wei Wang, Allison Park, PA (US); Steven V. Barancyk, Wexford, PA (US); Shiryn Tyebjee, Tarentum, PA (US); Hyun Wook Ro, Gibsonia, PA (US); Mark A. Tucker, Allison Park, PA (US); Andrew James Yarzebinski, Tarentum, PA (US)

(73) Assignee: PPG Industries Ohio, Inc., Cleveland, OH (US)

(21) Appl. No.: 18/259,328

(22) PCT Filed: Dec. 28, 2021
(86) PCT No.: PCT/US2021/065339

§ 371 Date: Jun. 26, 2023

Related U.S. Application Data
(60) Provisional application No. 63/130,966, filed on Dec. 28, 2020.

(51) Int. Cl. C08G 63/20; C08G 18/42; C08G 18/46; C08G 18/79; C09D 175/06

(52) U.S. Cl. CPC C08G 63/20; C08G 18/423; C08G 18/4241; C08G 18/4661; C08G 18/798; C09D 175/06

(57) ABSTRACT

A polyester polyol includes a reaction product obtained from: (i) a polyol including 3 or more hydroxyl groups; (ii) a dicarboxylic acid or an anhydride thereof that includes 3 carbon atoms or fewer between the carboxylic acid groups or the anhydride thereof; (iii) a monocarboxylic acid or an anhydride thereof; (iv) optionally a diol; and (v) optionally a dicarboxylic acid or an anhydride thereof that includes greater than 3 carbons between the carboxylic acid groups or the anhydride thereof. A molar ratio of (i)+(iv) to (ii)+(v) ranges from 1.08:1 to 1.75:1, and a molar ratio of (i)+(iv) to (iii) ranges from 1.25:1 to 4:1. The reaction product has a hydroxyl value of from 60 to 300 mg KOH/g, and an acid value of less than 15 mg KOH/g.

### FIELD OF THE INVENTION

The present invention relates to a polyester polyol and a coating composition formed therefrom.

### BACKGROUND OF THE INVENTION

Coatings are applied to a wide variety of substrates to provide color and other visual effects, corrosion resistance, abrasion resistance, chemical resistance, and the like.

Coatings for automotive applications such as primers, basecoats, and topcoats typically have a number of desirable properties. For example, use of low amounts of organic solvent in a coating composition is often desired for environmental reasons. Additionally, a high solids content coating is also often desired so that resin and pigment can be transferred to a substrate surface as efficiently as possible, resulting in increased application robustness. In addition to the properties listed above, the physical properties of a coating such as hardness, flexibility, and/or appearance should meet automotive industry standards. Attaining all of these characteristics is difficult and often certain properties have to be compromised so that other properties can be enhanced.

### SUMMARY OF THE INVENTION

The present invention is directed to a polyester polyol including a reaction product obtained from components including: (i) a polyol including 3 or more hydroxyl groups; (ii) a dicarboxylic acid or an anhydride thereof that includes 3 carbon atoms or fewer between the carboxylic acid groups or the anhydride thereof, (iii) a monocarboxylic acid or an anhydride thereof, (iv) from 0 weight % to less than 10 weight % of a diol, based on total solids of the components included to obtain the reaction product; and (v) from 0 weight % to less than 10 weight % of a dicarboxylic acid or an anhydride thereof that includes greater than 3 carbons between the carboxylic acid groups or the anhydride thereof, based on total solids of the components included to obtain the reaction product. A molar ratio of (i)+(iv) to (ii)+(v) ranges from 1.08:1 to 1.75:1, and a molar ratio of (i)+(iv) to (iii) ranges from 1.25:1 to 4:1. The reaction product has a hydroxyl value of from 60 to 300 mg KOH/g, and an acid value of less than 15 mg KOH/g.

### DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses the singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” polyester polyol, “an” acid, and the like refer to one or more of any of these items. Also, as used herein, the term “polymer” is meant to refer to prepolymers, oligomers, and both homopolymers and copolymers. The term “resin” is used interchangeably with “polymer”.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the invention.

The present invention is directed to polyester polyol comprising a reaction product obtained from components comprising: (i) a polyol comprising 3 or more hydroxyl groups; (ii) a dicarboxylic acid or an anhydride thereof that comprises 3 carbon atoms or fewer between the carboxylic acid groups or the anhydride thereof, (iii) a monocarboxylic acid or an anhydride thereof, (iv) from 0 weight % to less than 10 weight % of a diol, based on total solids of the components included to obtain the reaction product; and (v) from 0 weight % to less than 10 weight % of a dicarboxylic acid or an anhydride thereof that comprises greater than 3 carbons between the carboxylic acid groups or the anhydride thereof, based on total solids of the components included to obtain the reaction product; wherein a molar ratio of (i)+(iv) to (ii)+(v) (triol or higher+diol:dicarboxylic acid or anhydride) ranges from 1.08:1 to 1.75:1, and a molar ratio of (i)+(iv) to (iii) (triol or higher+diol:monocarboxylic acid or anhydride) ranges from 1.25:1 to 4:1, and wherein the reaction product comprises a hydroxyl value of from 60 to 300 mg KOH/g, and an acid value of less than 15 mg KOH/g.

A polyol comprising 3 or more hydroxyl groups is used in the reaction to form the polyester polyol. The polyol comprising 3 or more hydroxyl groups may comprise from 3 to 6 hydroxyl groups, such as from 3 to 4 hydroxyl groups. The polyol comprising 3 or more hydroxyl groups may comprise at least 3, such as at least 4, or at least 5 hydroxyl groups. The polyol comprising 3 or more hydroxyl groups may comprise up to 6, such as up to 5, or up to 4 hydroxyl groups.

The polyol comprising 3 or more hydroxyl groups may have a number average molecular weight (Mn) of less than 500 g/mol, such as less than 400 g/mol or less than 300 g/mol. Mn and/or weight average molecular weight (Mw) and/or z-average molecular weight (Mz), as reported herein, was determined, unless otherwise indicated, according to ASTM D6579-11 using size exclusion chromatography using a triple detector including a Waters 2695 separation module with a Wyatt Technology Light Scattering detector (miniDAWN), a differential refractive index detector (Optilab rEX)), and a Differential Viscometer detector (Viscostar). Tetrahydrofuran (THF) was used as the eluent at a flow rate of 1 ml min⁻¹, and three PL Gel Mixed C columns were used for separation. Samples with solvent were vacuum dried (without heating) prior to analysis. The performance of instrument was validated by a polystyrene standard of 30,000 Da. Polymer branching can be quantified using the Mark-Houwink parameter.

The polyol comprising 3 or more hydroxyl groups may include any polyols suitable for making polyesters. Non-limiting examples of trifunctional, tetrafunctional, or higher functional polyols suitable for use in in preparing the polyester polyol include, but are not limited to, branched chain alkane polyols such as glycerol or glycerin, tetramethylolmethane, trimethylolethane (for example 1,1,1-trimethylolethane), trimethylolpropane (TMP) (for example 1,1,1-trimethylolpropane), di(trimethylolpropane), erythritol, pentaerythritol, dipentaerythritol, tripentaerythritol, sorbitan, alkoxylated derivatives thereof and mixtures thereof. The polyol comprising 3 or more hydroxyl groups can be a cycloalkane polyol, such as trimethylene bis(1,3,5-cyclohexanetriol). The polyol comprising 3 or more hydroxyl groups can be an aromatic polyol, such as trimethylene bis(1,3,5-benzenetriol).

Further non-limiting examples of suitable polyols comprising 3 or more hydroxyl groups include the aforementioned polyols which can be alkoxylated derivatives, such as ethoxylated, propoxylated and butoxylated. In some non-limiting examples, the following polyols can be alkoxylated with from 1 to 10 alkoxy groups: glycerol, trimethylolethane, trimethylolpropane, benzenetriol, cyclohexanetriol, erythritol, pentaerythritol, sorbitol, mannitol, sorbitan, dipentaerythritol, and tripentaerythritol. Alkoxylated, e.g., ethoxylated and propoxylated, polyols and mixtures thereof can be used alone or in combination with unalkoxylated, unethoxylated and unpropoxylated polyols having at least three hydroxyl groups and mixtures thereof. The number of alkoxy groups can be from 1 to 10, or from 2 to 8 or any rational number from 1 to 10. In a non-limiting embodiment, the alkoxy group can be ethoxy and the number of ethoxy groups can be 1 to 5 units. In another non-limiting embodiment, the polyol can be trimethylolpropane having up to 2 ethoxy groups. Non-limiting examples of suitable alkoxylated polyols include ethoxylated trimethylolpropane, propoxylated trimethylolpropane, ethoxylated trimethylolethane, and mixtures thereof.

Mixtures of any of the above polyols comprising 3 or more hydroxyl groups can be used.

A dicarboxylic acid or an anhydride thereof is used in the reaction to form the polyester polyol. The dicarboxylic acid or an anhydride thereof has 3 carbon atoms or fewer between the carboxylic acid groups or the anhydride thereof (not including the carbons of the acid or anhydride groups).

Non-limiting examples of suitable dicarboxylic acids having 3 carbon atoms or fewer between the carboxylic acid groups include, but are not limited to, phthalic acid, isophthalic acid, tetrahydrophthalic acid, hexahydrophthalic acid, methylhexahydrophthalic acid, succinic acid, maleic acid, glutaric acid, chlorendic acid, tetrachlorophthalic acid, and other such dicarboxylic acids. Anhydrides of any of these acids may be used. Mixtures of any of the above-described dicarboxylic acids or anhydrides thereof may be used. The dicarboxylic acid having 3 carbon atoms or fewer between the carboxylic acid groups may be selected from the group of: methylhexahydrophthalic acid, hexahydrophthalic acid, phthalic acid, isophthalic acid, anhydrides thereof, or some mixture thereof. The dicarboxylic acid or anhydride thereof having 3 carbon atoms or fewer between the carboxylic acid (or anhydride) groups may comprise a cyclic substituted structure.

The dicarboxylic acid or anhydride thereof having 3 carbon atoms or fewer between the carboxylic acid groups or anhydride thereof may comprise cyclic content (e.g., phthalic acid/anhydride, methyl hexahydrophthalic acid/anhydride, etc.).

A monocarboxylic acid or an anhydride thereof is used in the reaction to form the polyester polyol. The monocarboxylic acid or anhydride thereof may be aliphatic. The monocarboxylic acid or anhydride thereof may comprise at least 6 carbon atoms, such as at least 8 carbon atoms, or at least 10 carbon atoms, and includes a single carboxylic acid functional group or anhydride thereof.

Non-limiting examples of suitable monocarboxylic acids include, but are not limited to, cycloaliphatic carboxylic acids including cyclohexane carboxylic acid, tricyclodecane carboxylic acid, and aromatic monocarboxylic acids including benzoic acid and t-butylbenzoic acid; C1-C18 aliphatic carboxylic acids such as acetic acid, propanoic acid, butanoic acid, hexanoic acid, oleic acid, linoleic acid, nonanoic acid, undecanoic acid, lauric acid, isononanoic acid, other fatty acids, and those derived from hydrogenated fatty acids of naturally occurring oils such as coconut oil fatty acid. Anhydrides of any of these acids may be used. Mixtures of any of the above-described monocarboxylic acids or anhydrides thereof may be used.

The components used to form the polyester polyol may be substantially free (less than 3 weight % based on total solids weight of the components used to form the polyester polyol) of monomers comprising 2 hydroxyl groups and an acid group, such as dimethylolpropionic acid (DMPA). The components used to form the polyester polyol may be essentially free (less than 1 weight % based on total solids weight of the components used to form the polyester polyol) of monomers comprising 2 hydroxyl groups and an acid group. The components used to form the polyester polyol may be free (0 weight % based on total solids weight of the components used to form the polyester polyol) of monomers comprising 2 hydroxyl groups and an acid group.

A diol may optionally be used in the reaction to form the polyester polyol. In other examples, the components that form the polyester polyol may be essentially free (less than 1 weight % based on total solids weight of the components used to form the polyester polyol) or free (0 weight % based on total solids weight of the components used to form the polyester polyol) of a diol.

The diol may make up from 0 weight % to less than 10 weight % of the components that form the polyester polyol. When included in the components, the diol may make up greater than 0 weight % and less than 10 weight % based on total solids weight of the components used to form the polyester polyol. The diol may make up from 0 weight % to 5 weight %, from 1 weight % to less than 10 weight %, or from 1 weight % to 5 weight % based on total solids weight of the components used to form the polyester polyol.

Non-limiting examples of suitable diols include, but are not limited to, alkylene glycols, such as ethylene glycol, propylene glycol, diethylene glycol, dipropylene glycol, 1,2-propylene glycol, triethylene glycol, tripropylene glycol, hexylene glycol, polyethylene glycol, polypropylene glycol and neopentyl glycol; hydrogenated bisphenol A; cyclohexanediol; propanediols including 1,2-propanediol, 1,3-propanediol, butyl ethyl propanediol, 2-methyl-1,3-propanediol, and 2-ethyl-2-butyl-1,3-propanediol; butanediols including 1,4-butanediol, 1,3-butanediol, and 2-ethyl-1,4-butanediol; pentanediols including trimethyl pentanediol and 2-methylpentanediol; 2,2,4-trimethyl-1,3-pentanediol, cyclohexanedimethanol; hexanediols including 1,6-hexanediol; 2-ethyl-1,3-hexanediol, caprolactonediol (for example, the reaction product of epsilon-caprolactone and ethylene glycol); hydroxyalkylated bisphenols; polyether glycols, for example, poly(oxytetramethylene)glycol; and the like. Mixtures of any of the above-described diols may be used.

A dicarboxylic acid or an anhydride thereof that comprises greater than 3 carbons between the carboxylic acid groups or the anhydride thereof (not including the carbons of the acid or anhydride groups) may optionally be used in the reaction to form the polyester polyol. In other examples, the components that form the polyester polyol may be essentially free (less than 1 weight % based on total solids weight of the components used to form the polyester polyol) or free (0 weight % based on total solids weight of the components used to form the polyester polyol) of a dicarboxylic acid or an anhydride thereof that comprises greater than 3 carbons between the carboxylic acid groups or the anhydride thereof. When referring to the number of carbons between functional groups, it will be understood that the number of carbons is based on the shortest carbon chain between specified functional groups (such as the shortest distance around a ring between functional groups in a compound that includes cyclic content).

The dicarboxylic acid or an anhydride thereof that comprises greater than 3 carbons between the carboxylic acid groups or the anhydride thereof may make up from 0 weight % to less than 10 weight % based on total solids weight of the components used to form the polyester polyol. When included in the components, the dicarboxylic acid or an anhydride thereof that comprises greater than 3 carbons between the carboxylic acid groups or the anhydride thereof may make up greater than 0 weight % and less than 10 weight % based on total solids weight of the components used to form the polyester polyol. The dicarboxylic acid or an anhydride thereof that comprises greater than 3 carbons between the carboxylic acid groups or the anhydride thereof may make up from 0 weight % to 5 weight %, from 1 weight % to less than 10 weight %, or from 1 weight % to 5 weight % based on total solids weight of the components used to form the polyester polyol.

Non-limiting examples of suitable dicarboxylic acids or an anhydrides thereof that comprise greater than 3 carbons between the carboxylic acid groups or the anhydride thereof include, but are not limited to, adipic acid, pimelic acid, suberic acid, azelaic acid, sebacic acid, terephthalic acid, and other such dicarboxylic acids. Anhydrides of any of these acids may be used. Mixtures of any of the above-described dicarboxylic acids or anhydrides thereof may be used.

The components used to form the polyester polyol may have a molar ratio of (i) the polyol comprising 3 or more hydroxyl groups+(iv) the diol: (ii) the dicarboxylic acid or an anhydride thereof that comprises 3 carbon atoms or fewer between the carboxylic acid groups or the anhydride thereof+(v) the dicarboxylic acid or an anhydride thereof that comprises greater than 3 carbons between the carboxylic acid groups or the anhydride thereof ranging from 1.08:1 to 1.75:1, such as from 1.08:1 to 1.7:1, from 1.08:1 to 1.67:1, or from 1.08:1 to 1.5:1.

The components used to form the polyester polyol may have a molar ratio of (i) the polyol comprising 3 or more hydroxyl groups+(iv) the diol: (iii) the monocarboxylic acid or an anhydride thereof ranging from 1.25:1 to 4:1, such as 1.5:1 to 2.5:1, or 1.3:1 to 2.5:1.

A carboxylic acid comprising 3 or more carboxylic acid groups, or an anhydride thereof may optionally be used in the reaction to form the polyester polyol. In other examples, the components that form the polyester polyol may be essentially free (less than 1 weight % based on total solids weight of the components used to form the polyester polyol) or free (0 weight % based on total solids weight of the components used to form the polyester polyol) of a carboxylic acid comprising 3 or more carboxylic acid groups, or an anhydride thereof.

The carboxylic acid comprising 3 or more carboxylic acid groups, or an anhydride thereof may make up from 0 weight % to less than 15 weight % based on total solids weight of the components used to form the polyester polyol. When included in the components, the carboxylic acid comprising 3 or more carboxylic acid groups, or an anhydride thereof may make up greater than 0 weight % and less than 15 weight % based on total solids weight of the components used to form the polyester polyol. The carboxylic acid comprising 3 or more carboxylic acid groups, or an anhydride thereof may make up from 0 weight % to 10 weight %, from 1 weight % to less than 15 weight %, or from 1 weight % to 10 weight % based on total solids weight of the components used to form the polyester polyol.

Non-limiting examples of suitable carboxylic acids comprising 3 or more carboxylic acid groups, or an anhydride thereof include, but are not limited to, trimellitic acid, cyclohexanetetra carboxylic acid, cyclobutane tetracarboxylic acid, pyromellitic acid, and other such carboxylic acids. Anhydrides of any of these acids may be used. Mixtures of any of the above-described suitable carboxylic acids comprising 3 or more carboxylic acid groups, or an anhydride thereof may be used.

The polyester polyol may comprise carbamate functionality. The polyester polyol may comprise carbamate functionality by reacting the polyester with methyl carbamate to exchange a portion of the hydroxyl functionality to impart pendant primary carbamate functionality onto the polymer.

The polyester polyol may have a hydroxyl value of from 60 to 300 mg KOH/g, such as from 90 to 280 mg KOH/g, from 100 to 250 mg KOH/g, or from 130 to 250 mg KOH/g. The polyester polyol may comprise from 3 to 8 hydroxyl groups per molecule, as determined stoichiometrically based on the moles of the components used to form the polyester polyol. The polyester polyol may have an acid value of less than 15 mg KOH/g. Acid values and hydroxyl values were determined using a Metrohm 798 MPT Titrino automatic titrator according to ASTM D 4662-15 and ASTM E 1899-16, respectively.

The polyester polyol may have an Mn of less than 7500 g/mol, such as less than 5000 g/mol, or less than 4500 g/mol. The polyester polyol may have a polydispersity index (Mw/Mn) (PDI) of up to 6.5.

The polyester polyol may include from 4 to 10 branching points, as determined stoichiometrically based on the moles of the components used to form the polyester polyol; branching points may be represented by the number of triols (or higher functional polyols) per molecule. The polyester polyol may exhibit an intrinsic viscosity of up to 8 mL/g, such as up to 7.5 mL/g. The Intrinsic viscosity was measured using the above-described triple detector. The intrinsic viscosity and molar mass measured by the triple detector can be used to generate Mark-Houwink plots, which are plots of Log([η]) vs. Log(M). A fit of this data to the Mark-Houwink equation: [η])=KM^{α}, yields the coefficient α. The Mark-Houwink parameter α of the present branched resins as measured by triple detector GPC may range from 0.15 to 0.4, such as 0.2 to 0.4.

A coating composition may be prepared using the polyester polyol as described herein. The coating composition includes the polyester polyol and a crosslinker reactive with the polyester polyol (e.g., the hydroxyl groups thereof). The coating composition may be cured to form a continuous coating layer over the substrate to which it is applied by a curing reaction between the polyester polyol and the crosslinker.

The crosslinker may include an isocyanate-functional compound, an aminoplast compound, an anhydride compound, a phenolic compound, or a combination thereof.

The isocyanate functional compound may include a free isocyanate crosslinker, a blocked isocyanate crosslinker, or a combination thereof. The isocyanate crosslinker may have a molecular weight of up to 600 g/mol (measured by gel permeation chromatography (GPC) as described herein). The isocyanate having such a low molecular weight may be included in a clear topcoat layer and function as a penetrating isocyanate that may penetrate to a coating layer beneath the clearcoat layer (in a multi-layer coating system) to facilitate cure of the coating layers beneath the clearcoat layer. The use of the penetrating isocyanate in the clearcoat layer may improve the humidity resistance of the multi-layer coating stack.

The aminoplast crosslinker may include melamine. The aminoplast crosslinker may include condensates of amines and/or amides with aldehyde. For example, the condensate of melamine with formaldehyde is an example of a suitable aminoplast.

The coating composition may include a second hydroxyl functional polymer different from the polyester polyol (prepared using different monomers and/or different monomer amounts). The second hydroxyl functional polymer may comprise an acrylic polymer. The second hydroxyl functional polymer may include at least two hydroxyl functional groups per molecule, such as an acrylic polymer having at least two hydroxyl functional groups per molecule.

The second hydroxyl functional polymer may be included in the coating composition such that the weight ratio of the polyester polyol to the second hydroxyl functional polymer in the coating composition is from 1:2 to 2:1, such as from 1:1.5 to 1.5:1, 1:1.25 to 1.25:1, or 1:1.1 to 1.1:1.

The polyester polyol comprises at least 5% of the total hydroxyl equivalence in the coating composition, such as at least 10%, at least 15%, at least 20%, or at least 25%. The polyester polyol may comprise from 5%-45% of the total hydroxyl equivalence in the coating composition, such as from 5%-35%, from 5%-30%, from 10%-30%, from 20%-30%, or from 25%-30%. Total hydroxyl equivalence refers to the percent of the hydroxyl groups bonded to the polyester polyol based on the total hydroxyl groups bonded to resin components contained in the coating composition.

The coating composition may have a solids content of at least 30%, such as at least 40%, at least 50%, at least 60%, or at least 70%. The coating composition may have a solids content ranging from 30% to 80%, such as from 40% to 80%, from 50% to 80%, from 60% to 80%, from 70% to 80%, from 30% to 70%, from 40% to 70%, from 50% to 70%, from 60% to 70%, from 30% to 60%, from 40% to 60%, or from 50% to 60%. Solids content (also referred to herein as “total solids”), as described herein, is measured by comparing initial sample weights to sample weights after exposure to 110° C. for 1 hour.

The coating composition can also include a pigment. The pigment may include a finely divided solid powder that is insoluble, but wettable, under the conditions of use. The pigment can be organic or inorganic and can be agglomerated or non-agglomerated. Pigments can be incorporated into the coating by use of a grind vehicle, such as an acrylic grind vehicle, the use of which will be familiar to one skilled in the art.

Suitable pigments and/or pigment compositions include, but are not limited to, carbazole dioxazine crude pigment, azo, monoazo, diazo, naphthol AS, salt type (flakes), benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, and mixtures thereof.

The pigment used with the coating composition can also comprise a special effect pigment. As used herein, a “special effect pigment” refers to a pigment that interacts with visible light to provide an appearance effect other than, or in addition to, a continuous unchanging color. Suitable special effect pigments include those that produce one or more appearance effects such as reflectance, pearlescence, metallic sheen, texture, phosphorescence, fluorescence, photochromism, photosensitivity, thermochromism, goniochromism, and/or color-change, such as transparent coated mica and/or synthetic mica, coated silica, coated alumina, aluminum flakes, a transparent liquid crystal pigment, a liquid crystal coating, or a combination thereof.

In some examples, the coating composition may be a clearcoat substantially free of a pigment. Substantially free of a pigment may mean that the coating composition comprises less than 3 weight % of pigment, based on total solids of the coating composition, such as less than 2 weight %, less than 1 weight %, or 0 weight %.

Other suitable materials that can be used with the coating composition include, but are not limited to, plasticizers, abrasion resistant particles, anti-oxidants, hindered amine light stabilizers, UV light absorbers and stabilizers, surfactants, flow and surface control agents, thixotropic agents, catalysts, reaction inhibitors, and other customary auxiliaries.

The coating composition may be curable at a temperature of less than or equal to 80° C., such that, when the coating composition is applied to a substrate to form a layer having a thickness from 5 to 100 microns and baked at 80° C. for 30 minutes, the layer achieves at least 100 MEK double rubs as measured according to ASTM 5402-19. The coating composition may be curable at ambient temperature (from 20° C. to 27° C., e.g., at 23° C.), such that, when the coating composition is applied to a substrate to form a layer having a thickness from 5 to 100 microns and left at ambient temperature for 24 hours, the layer achieves at least 100 MEK double rubs as measured according to ASTM 5402-19.

The coating composition may be applied to a substrate and cured to form a coating thereover. The coating may be a continuous film formed over at least a portion the substrate.

The substrate over which the coating composition may be applied includes a wide range of substrates. For example, the coating composition of the present invention can be applied to a vehicle substrate, an industrial substrate, an aerospace substrate, a packaging substrate and the like.

The vehicle substrate may include a component of a vehicle. In the present disclosure, the term “vehicle” is used in its broadest sense and includes all types of aircraft, spacecraft, watercraft, and ground vehicles. For example, the vehicle can include, but is not limited to an aerospace substrate (a component of an aerospace vehicle, such as an aircraft such as, for example, airplanes (e.g., private airplanes, and small, medium, or large commercial passenger, freight, and military airplanes), helicopters (e.g., private, commercial, and military helicopters), aerospace vehicles (e.g., rockets and other spacecraft), and the like). The vehicle can also include a ground vehicle such as, for example, animal trailers (e.g., horse trailers), all-terrain vehicles (ATVs), cars, trucks, buses, vans, heavy duty equipment, golf carts, motorcycles, bicycles, snowmobiles, trains, railroad cars, and the like. The vehicle can also include watercraft such as, for example, ships, boats, hovercrafts, and the like. The vehicle substrate may include a component of the body of the vehicle, such as an automotive hood, door, trunk, roof, and the like; such as an aircraft or spacecraft wing, fuselage, and the like; such as a watercraft hull, and the like.

The coating composition may be applied over an industrial substrate which may include tools, heavy duty equipment, furniture such as office furniture (e.g., office chairs, desks, filing cabinets, and the like), appliances such as refrigerators, ovens and ranges, dishwashers, microwaves, washing machines, dryers, small appliances (e.g., coffee makers, slow cookers, pressure cookers, blenders, etc.), metallic hardware, extruded metal such as extruded aluminum used in window framing, other indoor and outdoor metallic building materials, and the like.

The coating composition may be applied over storage tanks, windmills, nuclear plant components, packaging substrates, wood flooring and furniture, apparel, electronics, including housings and circuit boards, glass and transparencies, sports equipment, including golf balls, stadiums, buildings, bridges, and the like.

A package may be coated at least in part with any of the coating compositions described above. A “package” is anything used to contain another item, particularly for shipping from a point of manufacture to a consumer, and for subsequent storage by a consumer. A package will be therefore understood as something that is sealed so as to keep its contents free from deterioration until opened by a consumer. The manufacturer will often identify the length of time during which the food or beverage will be free from spoilage, which typically ranges from several months to years. Thus, the present “package” is distinguished from a storage package or bakeware in which a consumer might make and/or store food; such a package would only maintain the freshness or integrity of the food item for a relatively short period. “Package” as used herein means the complete package itself or any component thereof, such as an end, lid, cap, and the like. For example, a “package” coated with any of the coating compositions described herein might include a metal can in which only the can end or a portion thereof is coated. A package according to the present invention can be made of metal or non-metal, for example, plastic or laminate, and be in any form. An example of a suitable package is a laminate tube. Another example of a suitable package is metal can. The term “metal can” includes any type of metal can, package or any type of receptacle or portion thereof that is sealed by the food/beverage manufacturer to minimize or eliminate spoilage of the contents until such package is opened by the consumer. One example of a metal can is a food can; the term “food can(s)” is used herein to refer to cans, packages or any type of receptacle or portion thereof used to hold any type of food and/or beverage. “Beverage can” may also be used to refer more specifically to a food can in which a beverage is packaged. The term “metal can(s)” specifically includes food cans, including beverage cans, and also specifically includes “can ends” including “E-Z open ends”, which are typically stamped from can end stock and used in conjunction with the packaging of food and beverages. The term “metal cans” also specifically includes metal caps and/or closures such as bottle caps, screw top caps and lids of any size, lug caps, and the like. The metal cans can be used to hold other items as well, including, but not limited to, personal care products, bug spray, spray paint, and any other compound suitable for packaging in an aerosol can. The cans can include “two piece cans” and “three-piece cans” as well as drawn and ironed one-piece cans; such one piece cans often find application with aerosol products. Packages coated according to the present invention can also include plastic bottles, plastic tubes, laminates and flexible packaging, such as those made from PE, PP, PET and the like. Such packaging could hold, for example, food, toothpaste, personal care products and the like.

The coating composition may be applied to the interior and/or the exterior of the package. For example, the coating can be applied onto metal used to make a two-piece food can, two-piece beverage can, a three-piece food can, can end stock and/or cap/closure stock. The coating can be applied to the “side stripe” of a metal can, which will be understood as the seam formed during fabrication of a three-piece can. The coating can also be applied to caps and/or closures; such application can include, for example, a protective varnish that is applied before and/or after formation of the cap/closure and/or a pigmented enamel post applied to the cap, particularly those having a scored seam at the bottom of the cap. Decorated can stock can also be partially coated externally with the coating described herein, and the decorated, coated can stock used to form various metal cans. The coating can be applied to can stock before formation of the can or can part, or can be applied to the can or can part after formation.

Any material used for the formation of food cans can be treated according to the present methods. Particularly suitable substrates include aluminum, tin-plated steel, tin-free steel, and black-plated steel.

A method of coating a package comprises applying to at least a portion of the package any of the coating compositions described above, and curing the coating. Two-piece cans are manufactured by joining a can body (typically a drawn metal body) with a can end (typically a drawn metal end). The coatings of the present invention are suitable for use in food contact situations and may be used on the inside of such cans. They are particularly suitable to be spray applied on the interior of two-piece drawn and ironed beverage cans and coil coatings for food can ends. The present invention also offers utility in other applications. These additional applications include, but are not limited to, wash coating, sheet coating, and side seam coatings (e.g., food can side seam coatings).

Spray coating includes the introduction of the coating composition into the inside of a preformed package. Typical preformed packages suitable for spray coating include food cans, beer and beverage packages, and the like. The spray may utilize a spray nozzle capable of uniformly coating the inside of the preformed package. The sprayed preformed package is then subjected to heat to remove the residual solvents and harden the coating. For food inside spray, the curing conditions involve maintaining the temperature measured at the can dome at 350° F. to 500° F. (177° C. to 260° C.) for 0.5 to 30 minutes.

A sheet coating is described as the coating of separate pieces of a variety of materials (e.g., steel or aluminum) that have been pre-cut into square or rectangular “sheets.” Typical dimensions of these sheets are approximately one square meter. Once coated, each sheet is cured. Once hardened (e.g., dried and cured), the sheets of the coated substrate are collected and prepared for subsequent fabrication. Sheet coatings provide coated metal (e.g., steel or aluminum) substrate that can be successfully fabricated into formed articles, such as 2-piece drawn food cans, 3-piece food cans, food can ends, drawn and ironed cans and the like.

A side seam coating is described as the spray application of a coating over the welded area of formed three-piece food cans. When three-piece food cans are being prepared, a rectangular piece of coated substrate is formed into a cylinder. The formation of the cylinder is rendered permanent due to the welding of each side of the rectangle via thermal welding. Once welded, each can typically require a layer of coating, which protects the exposed “weld” from subsequent corrosion or other effects to the contained foodstuff. The coatings that function in this role are termed “side seam stripes”. Typical side seam stripes are spray applied and cured quickly via residual heat from the welding operation in addition to a thermal, infrared, and/or electromagnetic oven.

The substrate can be metallic or non-metallic. Metallic substrates include, but are not limited to, tin, steel (including electrogalvanized steel, cold rolled steel, hot-dipped galvanized steel, among others), aluminum, aluminum alloys, zinc-aluminum alloys, steel coated with a zinc-aluminum alloy, and aluminum plated steel. Non-metallic substrates include polymeric materials, plastic and/or composite material, polyester, polyolefin, polyamide, cellulosic, polystyrene, polyacrylic, poly(ethylene naphthalate), polypropylene, polyethylene, nylon, ethylene vinyl alcohol (EVOH), polylactic acid, other “green” polymeric substrates, poly(ethyleneterephthalate) (PET), polycarbonate, polycarbonate acrylobutadiene styrene (PC/ABS), wood, veneer, wood composite, particle board, medium density fiberboard, cement, stone, glass, paper, cardboard, textiles, leather, both synthetic and natural, and the like. The substrate may comprise a metal, a plastic and/or composite material, and/or a fibrous material. The fibrous material may comprise a nylon and/or a thermoplastic polyolefin material with continuous strands or chopped carbon fiber. The substrate can be one that has already been treated in some manner, such as to impart visual and/or color effect, a protective pretreatment or other coating layer, and the like.

The coating composition of the present invention may be particularly beneficial when applied to a metallic substrate. The coatings of the present invention may be particularly beneficial when applied to metallic substrates that are used to fabricate automotive vehicles, such as cars, trucks, and tractors.

The coating composition may be applied to a substrate having multiple components, wherein the coating composition is simultaneously applied to the multiple components and simultaneously cured to form a coating over the multiple components without deforming, distorting, or otherwise degrading any of the components. The components may be parts of a larger whole of the substrate. The components may be separately formed and subsequently arranged together to form the substrate. The components may be integrally formed to form the substrate.

Non-limiting examples of components of a substrate in the vehicle context include a vehicle body (e.g., made of metal) and a vehicle bumper (e.g., made of plastic) which are separately formed and subsequently arranged to form the substrate of the vehicle. Further examples include a plastic automotive component, such as a bumper or fascia in which the bumper or fascia comprises regions or subcomponents which comprise more than one type of substrate. Further examples include aerospace or industrial components comprising more than one substrate type. It will be appreciated that other such other multi-component substrates are contemplated within the context of this disclosure.

The multiple components may include at least a first component and a second component, and the first component and the second component may be formed from different materials. As used herein, “different materials” refers to the materials used to form the first and second component having different chemical make-ups.

The different materials may be from the same or different class of materials. As used herein, a “class of materials” refers to materials that may have a different specific chemical make-up but share the same or similar physical or chemical properties. For example, metals, polymers, ceramics, and composites may be defined as different classes of materials. However, other classes of materials may be defined depending on similarities in physical or chemical properties, such as nanomaterials, biomaterials, semiconductors, and the like. Classes of materials may include crystalline, semi-crystalline, and amorphous materials. Classes of materials, such as for polymers, may include thermosets, thermoplastics, elastomers, and the like. Classes of materials, such as for metals, may include alloys and non-alloys. As will be appreciated from the above exemplary list of classes, other relevant classes of materials may be defined based on a given physical or chemical property of materials.

The first component may be formed from a metal, and the second component may be formed from a plastic or a composite. The first component may be formed from a plastic, and the second component may be formed from a metal or a composite. The first component may be formed from a composite, and the second component may be formed from a plastic or a metal. The first component may be formed from a first metal, and the second component may be formed from a second metal different from the first metal. The first component may be formed from a first plastic, and the second component may be formed from a second plastic different from the first plastic. The first component may be formed from a first composite, and the second component may be formed from a second composite different from the first composite. As will be appreciated from these non-limiting examples, any combination of different materials from the same or different classes may form the first and second components.

Examples of combinations of materials include thermoplastic polyolefins (TPO) and metal, TPO and acrylonitrile butadiene styrene (ABS), TPO and acrylonitrile butadiene styrene/polycarbonate blend (ABS/PC), polypropylene and TPO, TPO and a fiber reinforced composite, and other combinations. Further examples include aerospace substrates or industrial substrates comprising various components made of a plurality of materials, such as various metal-plastic, metal-composite, and/or plastic-composite containing components. The metals may include ferrous metals and/or non-ferrous metals. Non-limiting examples of non-ferrous metals include aluminum, copper, magnesium, zinc, and the like, and alloys including at least one of these metals. Non-limiting examples of ferrous metals include iron, steel, and alloys thereof.

The first component and the second component (the materials thereof) may exhibit different physical or chemical properties when exposed to elevated temperatures. For example, the first component may deform, distort, or otherwise degrade at a temperature lower than the second component. Non-limiting examples of material properties which may indicate whether a first component deforms, distorts, or otherwise degrades at a temperature lower than the second component include: heat deflection temperature, embrittlement temperature, softening point, and other relevant material properties associated with deformation, distortion, or degradation of materials.

For example, the first component may deform, distort, or otherwise degrade at temperatures ranging from above 80° C. to 120° C., whereas the second component may not deform, distort, or otherwise degrade at temperatures within or below this range. The first component may deform, distort, or otherwise degrade at temperatures below 120° C., such as below 110° C., below 100° C., or below 90° C., whereas the second component may not deform, distort, or otherwise degrade at temperatures within these ranges.

When the coating composition is applied to the substrate having multiple components simultaneously, the applied coating composition may be cured at a temperature which does not deform, distort, or otherwise degrade either of the first and second component (the materials thereof). Thus, the curing temperature may be below the temperature at which either of the first component or the second component would deform, distort, or otherwise degrade. The coating composition may be cured at temperatures ranging from 80° C. to 120° C. where neither the first component nor the second component would deform, distort, or otherwise degrade within that range. The coating composition may be cured at temperatures less than or equal to 120° C., less than or equal to 110° C., less than or equal to 100° C., less than or equal to 90° C., or less than or equal to 80° C. where neither the first component nor the second component would deform, distort, or otherwise degrade within these ranges.

Therefore, the coating composition may be curable at relatively low temperatures, within the ranges mentioned above, such that components formed from different materials may be simultaneously coated with the coating composition and cured to form a coating thereover without deforming, distorting, or otherwise degrading either component.

The coating composition may be applied to the substrate by any suitable means, such as spraying, electrostatic spraying, dipping, rolling, brushing, and the like.

The coating composition can be applied to a substrate to form a pigmented topcoat. The pigmented topcoat may be the topmost coating layer so as not to include a clearcoat or any other coating layer thereover. The pigmented topcoat may be applied directly to the substrate. The pigmented topcoat may be applied over a primer layer or a pretreatment layer.

The coating composition can be applied to a substrate as a coating layer of a multi-layer coating system, such that one or more additional coating layers are formed below and/or above the coating formed from the coating composition.

The coating composition can be applied to a substrate as a primer coating layer of the multi-layer coating system. A “primer coating layer” refers to an undercoating that may be deposited onto a substrate (e.g., directly or over a pre-treatment layer) in order to prepare the surface for application of a protective or decorative coating system.

The coating composition can be applied to a substrate as a basecoat layer of the multi-layer coating system. A “basecoat” refers to a coating that is deposited onto a primer overlying a substrate and/or directly onto a substrate, optionally including components (such as pigments) that impact the color and/or provide other visual impact. A first basecoat layer may be applied over at least a portion of a substrate, wherein the first basecoat layer is formed from a first basecoat composition. A second basecoat layer may be applied over at least a portion of the first basecoat layer, wherein the second basecoat layer is formed from a second basecoat composition. The second basecoat layer may be applied after the first basecoat composition has been cured to form the first basecoat layer or may be applied in a wet-on-wet process prior to curing the first basecoat composition, after which the first and second basecoat compositions are simultaneously cured to form the first and second basecoat layers. A clearcoat may be applied over the basecoat layer.

The coating composition can be applied to a substrate as a topcoat layer of the multi-layer coating system. A “topcoat” refers to an uppermost coating that is deposited over another coating layer, such as a basecoat, to provide a protective and/or decorative layer, such as the previously described pigmented topcoat.

The topcoat layer used with the multi-layer coating system of the present invention may be a clearcoat layer, such as a clearcoat layer applied over a basecoat layer. As used herein, a “clearcoat” refers to a coating layer that is at least substantially transparent or fully transparent. The term “substantially transparent” refers to a coating, wherein a surface beyond the coating is at least partially visible to the naked eye when viewed through the coating. The term “fully transparent” refers to a coating, wherein a surface beyond the coating is completely visible to the naked eye when viewed through the coating. It is appreciated that the clearcoat can comprise pigment provided that the pigment does not interfere with the desired transparency of the clearcoat. The clearcoat can be substantially free or free of pigment.

Preparing the multi-layer coating system may include applying a topcoat composition (e.g., the coating composition of the present invention) onto at least a portion of the second basecoat composition. The topcoat composition may be applied onto the second basecoat composition prior to or after curing the first and second basecoat compositions. The first basecoat composition, the second basecoat composition, and the topcoat composition may be simultaneously cured at a temperature of 100° C. or less, such as 80° C. or less.

### EXAMPLES

The following examples are presented to demonstrate the general principles of the invention. The invention should not be considered as limited to the specific examples presented.

### Examples 1-14

### Preparation of Polyester Polyols

### Example 1 (Polyester 1)

To a four necked, 5 liter reaction flask outfitted with a stirrer, gas inlet, thermometer, small packed column and condenser, was added the contents of Charge 1. The contents were heated to 130° C. and held for 1 hour. Charge 2 was then added and the mixture was heated to 160° C. and held for 1 hour. The temperature was then raised in stages by 20° C. increments with an intermediate hold of 60 minutes at each temperature to a maximum temperature of 220° C. as water distillate was collected until an acid value of 5 (measured as previously described) was reached. The mixture was then cooled to 100° C. and thinned with Charge 3. The contents of Charges 1-3 are shown in Table 1.

TABLE 1

| Charge | Raw Material | Amount (g) |
|---|---|---|
| Charge 1 | Trimethylolpropane (TMP) | 321.6 |
| | Methyl Hexahydrophthalic anhydride | 1209.6 |
| | (mHHPA) | |
| | Butylstannoic acid | 3.0 |
| | Triphenyl phosphite | 3.0 |
| Charge 2 | Trimethylolpropane (TMP) | 964.8 |
| | Isononanoic acid (C9 acid) | 758.4 |
| Charge 3 | Butyl Acetate | 759 |

The final resin had a solids content of 80% (measured as previously described), a Gardner Holdt viscosity of Z1, as measured according to ASTM D1545-98, and an OH value (measured as previously described) of 144. The gel permeation chromatography (GPC) of the polyester was measured by triple detector (Mn 1580/Mw 3240). The intrinsic viscosity (q) of the polyester was 3.65 mL/g. The Mark-Houwink coefficient of the polyester was 0.28, indicating a significant degree of polymer branching. The Tg of the polyester was measured to be 3° C., as measured herein according to ASTM D3418-12.

### Examples 2-14 (Polyesters 2-14)

Polyesters based upon Polyester 1 (by changing the amount of components (TMP, mHHPA, C9 acid) in Table 1 to achieve the molar ratios specified in Table 2) with varying molecular weight and branching points were prepared. The molar composition along with the triple detector GPC data is tabulated below in Table 2.

TABLE 2

| | | | TMP:mHHPA | C9 | | | OH | | | | | |
|---|---|---|---|---|---|---|---|---|---|---|---|---|
| | TMP | mHHPA | (molar | Acid | Solids | Hydroxyl | Functionality/ | | | | Mark | Intrinsic |
| Polyester | (moles) | (moles) | ratio) | (moles) | Content | Value | Molecule | Mn | Mw | Mz | Houwink | Viscosity |
| Comparative | 2 | 1 | 2 | 1 | 80 | 302 | 3 | 510 | 1067 | 1860 | 0.11 | 2.87 |
| Polyester 9 | | | | | | | | | | | | |
| Polyester 10 | 2.5 | 1.5 | 1.67 | 1.5 | 80 | 280 | 3 | 7321 | 1570 | 2893 | 0.15 | 3.2 |
| Polyester 2 | 3 | 2 | 1.5 | 2 | 80 | 195 | 3 | 1160 | 2398 | 12220 | 0.30 | 3.65 |
| Polyester 1 | 4 | 3 | 1.33 | 2 | 80 | 185 | 4 | 1580 | 3244 | 6700 | 0.28 | 4.1 |
| Polyester 3 | 5 | 4 | 1.25 | 2.5 | 80 | 152 | 4.5 | 1870 | 5200 | 13210 | 0.32 | 4.8 |
| Polyester 4 | 6 | 5 | 1.2 | 3 | 80 | 138 | 5 | 1860 | 7720 | 23710 | 0.33 | 5.3 |
| Polyester 5 | 7 | 6 | 1.17 | 3 | 70 | 155 | 6 | 2664 | 9644 | 29500 | 0.33 | 5.5 |
| Polyester 6 | 8 | 7 | 1.14 | 4 | 75 | 122 | 6 | 3264 | 11460 | 50400 | 0.36 | 6.2 |
| Polyester 7 | 9 | 8 | 1.13 | 5 | 75 | 105 | 6 | 3430 | 14430 | 52000 | 0.36 | 6.2 |
| Polyester 8 | 10 | 9 | 1.11 | 6 | 70 | 93 | 6 | 4190 | 25280 | 113100 | 0.37 | 7.2 |
| Polyester 11 | 12 | 11 | 1.09 | 8 | 70 | 74 | 6 | NM | NM | NM | NM | NM |
| Polyester 12 | 14 | 13 | 1.08 | 10 | 70 | 62 | 6 | NM | NM | NM | NM | NM |
| Polyester 13 | 4 | 3 | 1.33 | 1 | 80 | 179 | 5 | 1490 | 2957 | 5794 | 0.26 | 4.68 |
| Polyester 14 | 5 | 4 | 1.25 | 4 | 80 | 122 | 4 | 1841 | 6948 | 20560 | 0.29 | 4.59 |

NM—Not Measured

Coating compositions using Polyesters 1-14 were prepared with a standard additive package: BYK 320 and BYK 306 (silicone-containing surface additives available from BYK-Chemie GmbH (Wesel, Germany)) each at 0.100 on polyol solids, dibutyltin dilaurate (DBTDL) catalyst at 0.2% on polyol solids, 3% isononanoic acid on polyol solids, and DESMODUR N 3900 (low viscosity, aliphatic polyisocyanate resin based on hexamethylene diisocyanate available from Covestro (Leverkusen, Germany)) as the crosslinking isocyanate at an NCO:OH ratio of 1:1. Butyl acetate was the reducing solvent. Viscosity was measured with a Brookfield CAP 2000 Viscometer using a #1 spindle at 75 rpm at 23° C.

The coating compositions were applied with a 6 mil drawdown bar over galvanized steel panel with a high edge corrosion electrocoat (ED 6450 HIA test panel from ACT Test Panels, LLC (Hillsdale, MI)) and baked for 30 minutes at 80° C. Appearance was measured with a BYK Gardner Wavescan Dual (Model No. 4840), and hardness was measured on a BYK Gardner Konig Hardness Tester (Model No. 5858) according to ASTM D4366-16. Table 3 shows the results of the coating compositions formed from Polyesters 1-14.

TABLE 3

| | | | König | | | | | | | |
|---|---|---|---|---|---|---|---|---|---|---|
| | % | Viscosity | Hardness | | | | | | | |
| Polyester | TS | (cps) | (s) | du | Wa | Wb | Wc | Wd | We | DOI |
| Comparative | 60 | 20 | 132 | 1.4 | 3.1 | 11 | 8 | 7 | 8 | 95.5 |
| Polyester 9 | | | | | | | | | | |
| Polyester 10 | 60 | 21 | 165 | 1 | 3.4 | 9 | 7 | 8 | 9 | 95.7 |
| Polyester 2 | 65 | 59 | 173 | 2 | 4 | 15 | 17 | 13 | 12 | 95 |
| Polyester 1 | 60 | 30 | 173 | 1.5 | 3.9 | 10 | 8 | 6 | 5 | 95.6 |
| Polyester 3 | 60 | 46 | 178 | 2.4 | 5.8 | 15 | 13 | 10 | 8 | 94.5 |
| Polyester 4 | 60 | 56 | 169 | 1.7 | 3.2 | 9 | 14 | 11 | 13 | 95.7 |
| Polyester 5 | 58 | 52 | 184 | 2.9 | 5.9 | 18 | 18 | 12 | 12 | 93.8 |
| Polyester 6 | 58 | 63 | 181 | 3.4 | 6.3 | 19 | 19 | 12 | 14 | 93.4 |
| Polyester 7 | 58 | 67 | 173 | 4.3 | 6.2 | 20 | 20 | 16 | 14 | 92.9 |
| Polyester 8 | 58 | 81 | 173 | 4.4 | 7.4 | 24 | 23 | 15 | 16 | 92.0 |
| Polyester 11 | 56 | 72 | 156 | 6 | 8 | 22 | 29 | 20 | 21 | 92 |
| Polyester 12 | 56 | 73 | 146 | 5 | 7 | 21 | 30 | 21 | 22 | 92 |
| Polyester 13 | 60 | 35 | 164 | 2 | 4 | 13 | 13 | 10 | 8 | 95 |
| Polyester 14 | 60 | 42 | 140 | 3 | 7 | 21 | 19 | 16 | 14 | 93.2 |

Polyesters with mole ratio of triol:dicarboxylic acid in the range of 1.75 to 1.08 show good hardness and appearance results. Polyesters with mole ratio of triol:dicarboxylic acid in the range of 1.75 to 1.08 exhibited a desirably high hardness. Moreover, the polyesters with mole ratio of triol:dicarboxylic acid in the range of 1.75 to 1.08 exhibited good appearance properties, as evidenced by the low du, Wa, Wb, We, Wd, We, and high DOI values. Low du, Wa, Wb, Wc, Wd, We, and high DOI values indicate that the coating has a smooth surface, corresponding to a good appearance of the coating.

### Example 15

### Preparation of a Polyester Polyol

To a four necked, 5 liter reaction flask outfitted with a stirrer, gas inlet, thermometer, small packed column and condenser, was added the contents of Charge 1. The contents were heated to 130° C. and held for 1 hour. Charge 2 was then added and the mixture was heated to 160° C. and held for 1 hour. The temperature was then raised in stages by 20° C. increments with an intermediate hold at each temperature to a maximum temperature of 220° C. as water distillate was collected until an acid value of 5 was reached. The mixture was then cooled to 100° C. and thinned with Charge 3. The contents of Charges 1-3 are shown in Table 4.

TABLE 4

| Charge | Raw Material | Amount (g) |
|---|---|---|
| Charge 1 | Pentaerythritol | 231.2 |
| | Methyl Hexahydrophthalic anhydride | 1142.4 |
| | Butylstannoic acid | 2.9 |
| | Triphenyl phosphite | 2.9 |
| Charge 2 | Trimethylolpropane | 911.2 |
| | Isononanoic acid | 805.8 |
| Charge 3 | Butyl Acetate | 719 |

The final resin had a solids of 80%, a Gardner Holdt viscosity of Z3/Z4, and an OH value of 135. The GPC of the polyester was measured by triple detector (Mn 1928/Mw 6300), and the polyester had an intrinsic viscosity of 4.62 mL/g and a Mark-Houwink coefficient of 0.31, indicating a significant degree of polymer branching. The polymer Tg was measured to be 6° C. The ratio of polyol (including diols) to diacid (or anhydride thereof) was 1.25.

### Comparative Example 16

### Preparation of a Polyester Polyol

A polyester of composition 23% 1,6-hexanediol, 8.2% 2,2,4-trimethylpentanediol, 18.6% trimethylolpropane, 18.5% adipic acid, and 32% methyl hexahydrophthalic anhydride was prepared (percents in weight %). The resin had a solids content of 80, an acid value from 5-12, and an OH value of 145. The GPC of the polyester was measured by triple detector (Mn 1324/Mw 3460), and the polyester had an intrinsic viscosity of 6.03 mL/g and a Mark-Houwink coefficient of 0.43, indicating some degree of polymer branching.

### Comparative Example 17

### Preparation of an Acrylic Polyol

An acrylic polyol of composition 20% styrene, 23% 2-ethylhexylmethacrylate, 21% 2-ethylhexylacrylate, 35% hydroxyethylmethacrylate and 1% acrylic acid was prepared (percents in weight %). The theoretical Tg calculated using the Fox Equation was 3° C. The resin had a solids content of 60%, and acid value <5, and an OH value of 82. The GPC of the acrylic was measured by triple detector (Mn 4550/Mw 8770) and had a Mark-Houwink coefficient of 0.53 indicating minimal branching.

Coating compositions using the polymers prepared in Examples 1 and 15-17 were prepared with a standard additive package: BYK 320/BYK 306 each at 0.1% on polyol solids, DBTDL catalyst at 0.2% on polyol solids, DESMODUR N 3900 as the crosslinking isocyanate at an NCO:OH ratio of 1:1, and butyl acetate as the reducing solvent. Each of the coating compositions prepared using the polyols of Examples 1 and 15-17 were prepared to contain the same resin solids content. Viscosity was measured with the CAP 2000 Viscometer. Table 5 shows the amounts of each component (grams) in the coating compositions.

TABLE 5

| | | | Comparative | Comparative |
|---|---|---|---|---|
| Component | Example 1 | Example 15 | Example 16 | Example 17 |
| A Pack | | | | |
| Polyester 1 | 31.3 | — | — | — |
| Polyester 15 | — | 31.3 | — | — |
| Comparative | — | — | 31.3 | — |
| Polyester 16 | | | | |
| Comparative | — | — | — | 41.7 |
| Acrylic 17 | | | | |
| BYK 320¹ | 0.05 | 0.05 | 0.05 | 0.05 |
| BYK 306² | 0.20 | 0.20 | 0.20 | 0.20 |
| DBTDL | 0.05 | 0.05 | 0.05 | 0.05 |
| Butyl Acetate | 11.4 | 11.4 | 11.4 | 11.4 |
| B Pack | | | | |
| DESMODUR N | 15.9 | 14.3 | 15.6 | 12.9 |
| 3900³ | | | | |
| Butyl Acetate | 9.5 | 8.4 | 9.5 | 10 |

¹Silicone-containing surface additive available from BYK-Chemie GmbH (Wesel, Germany)
²Silicone-containing surface additive available from BYK-Chemie GmbH (Wesel, Germany)
³Low viscosity, aliphatic polyisocyanate resin based on hexamethylene diisocyanate available from Covestro (Leverkusen, Germany)

The coating compositions were applied with a 6 mil drawdown bar over a galvanized steel panel with a high edge corrosion electrocoat (ED 6450 HIA test panel) and baked for 30 minutes at 80° C. Appearance was measured with the BYK Wavescan, and hardness was measured on the Konig pendulum device. Table 6 shows the results of the coating compositions of Examples 1 and 15-17.

TABLE 6

| | % | Visco | König | | | | | | | | |
|---|---|---|---|---|---|---|---|---|---|---|---|
| Resin | TS | (cps) | (s) | | du | Wa | Wb | Wc | Wd | We | DOI |
| Example 1 | 60 | 28 | 170 | s | 2 | 3 | 9 | 13 | 10 | 13 | 96 |
| (Polyester 1) | | | | | | | | | | | |
| Example 15 | 60 | 39 | 168 | s | 3 | 4 | 15 | 23 | 19 | 12 | 94 |
| (Polyester 15) | | | | | | | | | | | |
| Comparative | 60 | 43 | 10 | s | 2 | 3 | 7 | 9 | 10 | 11 | 96 |
| Example 16 | | | | | | | | | | | |
| (Comparative | | | | | | | | | | | |
| Polyester 16) | | | | | | | | | | | |
| Comparative | 50 | 32 | 96 | s | 15 | 28 | 51 | 46 | 29 | 22 | 81 |
| Example 17 | | | | | | | | | | | |
| (Comparative | | | | | | | | | | | |
| Acrylic 17) | | | | | | | | | | | |

Examples 1 and 15 exhibited a good balance of high hardness and good shortwave filling (low du/Wa/Wb, high DOI) values achieved with the polyester coating compositions of the present disclosure, compared to Comparative Examples 16 and 17.

### Examples 18-23

### Preparation of a Polyester Polyol with Varied Dicarboxylic Acids/Anhydrides

Polyesters with different dicarboxylic acids/anhydrides were prepared using the same components from Table 1 and setting the mole ratio of triol:diacid:monoacid at 4:3:2. The influence of carboxylic acid type on polymer polydispersity and coating properties is summarized in Tables 7 and 8.

TABLE 7

| | | | C9 | | | | | | |
|---|---|---|---|---|---|---|---|---|---|
| | TMP | Diacid/ | Acid | OH | | | | Mark | Intrinsic |
| Example | (moles) | Dianhydride | (moles) | Funct | Mn | Mw | Mz | Houwink | Viscosity |
| Example 18 | 4 | Succinic | 2 | 4 | 1505 | 5383 | 17570 | 0.35 | 5.23 |
| | | (anhydride) | | | | | | | |
| Example 19 | 4 | mHHPA | 2 | 4 | 1580 | 3244 | 6700 | 0.28 | 4.14 |
| | | (anhydride) | | | | | | | |
| Example 20 | 4 | HHPA | 2 | 4 | 1201 | 3079 | 6925 | 0.25 | 4.06 |
| | | (anhydride) | | | | | | | |
| Example 21 | 4 | Phthalic | 2 | 4 | 1433 | 3009 | 6021 | 0.19 | 4.09 |
| | | (anhydride) | | | | | | | |
| Example 22 | 4 | Isophthalic | 2 | 4 | 1829 | 6583 | 19900 | 0.30 | 5.4 |
| | | (acid) | | | | | | | |
| Comparative | 4 | Adipic | 2 | 4 | 1720 | 6821 | 24610 | 0.37 | 7.06 |
| Example 23 | | (acid) | | | | | | | |

TABLE 8

| | Diacid/ | % | Visco | König | | | | | | | |
|---|---|---|---|---|---|---|---|---|---|---|---|
| Example | Dianhydride | TS | (cps) | (s) | du | Wa | Wb | Wc | Wd | We | DOI |
| Example 18 | Succinic | 65 | 65 | 129 | 6 | 14 | 39 | 28 | 20 | 12 | 88 |
| | (anhydride) | | | | | | | | | | |
| Example 19 | mHHPA | 60 | 30 | 166 | 2 | 4 | 10 | 9 | 7 | 8 | 96 |
| | (anhydride) | | | | | | | | | | |
| Example 20 | HHPA | 60 | 46 | 170 | 3 | 4 | 22 | 19 | 12 | 12 | 93 |
| | (anhydride) | | | | | | | | | | |
| Example 21 | Phthalic | 60 | 44 | 186 | 6 | 10 | 28 | 24 | 16 | 12 | 91 |
| | (anhydride) | | | | | | | | | | |
| Example 22 | Isophthalic | 60 | 92 | 167 | 7 | 13 | 38 | 33 | 22 | 16 | 88 |
| | (acid) | | | | | | | | | | |
| Comparative | Adipic | 60 | 43 | 32 | 5 | 5 | 9 | 28 | 24 | 10 | 91 |
| Example 23 | (acid) | | | | | | | | | | |

The data indicates that polyols formed using dicarboxylic acids or anhydrides thereof comprising 3 carbon atoms or fewer between the carboxylic acid groups or the anhydride thereof generally provided better molecular weight control and balance of properties (e.g., hardness and appearance) in the cured coatings. The data further indicates that polyols formed using cyclic substituted anhydride structures generally provided better molecular weight control and balance of properties (e.g., hardness and appearance) in the cured coatings.

### Examples 24-27

### Preparation of a Polyester Polyol with Varied Levels of mHHPA and Adipic Acid

Polyesters with varying levels of mHHPA and adipic acid were prepared, all with the overall molar composition 4 moles TMP:3 moles dicarboxylic acid:2 moles monocarboxylic acid to evaluate the effect of partial replacement of mHTHPA by dicarboxylic acid with 4 carbons atom between the terminal acid groups. The influence of levels of mHHPA and adipic acid on polymer polydispersity and coating properties is summarized in Tables 9 and 10. The coating compositions prepared using the polyester polyols reported in Table 9, the properties of which are reported in Table 10, were prepared using the components included in Table 5 except substituting in the polyester polyol described in Table 9 as the polyester.

TABLE 9

| | | | | C9 | | | | | |
|---|---|---|---|---|---|---|---|---|---|
| | TMP | mHHPA | Adipic | Acid | | | | Mark | Intrinsic |
| Example | (moles) | (moles) | (moles) | (moles) | Mn | Mw | Mz | Houwink | Viscosity |
| Example 24 | 4 | 3 | 0 | 2 | 1580 | 3224 | 6700 | 0.28 | 4.14 |
| Example 25 | 4 | 2 | 1 | 2 | 1793 | 4621 | 11560 | 0.35 | 4.86 |
| Comparative | 4 | 1 | 2 | 2 | 1799 | 5328 | 15370 | 0.38 | 5.62 |
| Example 26 | | | | | | | | | |
| Comparative | 4 | 0 | 3 | 2 | 1720 | 6821 | 24610 | 0.37 | 7.06 |
| Example 27 | | | | | | | | | |

TABLE 10

| | % | Visco | König | | | | | | | |
|---|---|---|---|---|---|---|---|---|---|---|
| Example | TS | (cps) | (s) | du | Wa | Wb | Wc | Wd | We | DOI |
| Example 24 | 60 | 30 | 166 | 2 | 4 | 10 | 9 | 7 | 8 | 96 |
| Example 25 | 60 | 37 | 151 | 2 | 4 | 10 | 8 | 8 | 10 | 95 |
| Comparative | 60 | 37 | 81 | 2 | 4 | 12 | 10 | 7 | 9 | 95 |
| Example 26 | | | | | | | | | | |
| Comparative | 60 | 43 | 32 | 5 | 9 | 28 | 24 | 16 | 10 | 91 |
| Example 27 | | | | | | | | | | |

As the mHHPA is replaced with increasing levels of adipic acid, the polydispersity of the ensuing polymer increases, the hardness of the cured coating decreases, and shortwave structure (Wb) of the coating increases.

### Examples 28-32

### Preparation of a Polyester Polyol with Varied Levels of TMP and THEIC

Polyesters with varying levels of trimethylolpropane (TMP) and trishydroxyethyl isocyanurate (THEIC) were prepared all with the overall molar composition 4 moles triol:3 moles dicarboxylic acid:2 moles monocarboxylic acid to evaluate the effect of effect of varying the distance between distal OH bonds in the triol monomer. The terminal OH groups in TMP are located 3 atoms apart and the OH groups in THEIC are located 7 atoms apart. The influence oflevels of varying levels of TMP and THEIC on polymer polydispersity and coating properties is summarized in Tables 11 and 12. The coating compositions prepared using the polyester polyols reported in Table 11, the properties of which are reported in Table 12, were prepared using the components included in Table 5 except substituting in the polyester polyol described in Table 11 as the polyester.

TABLE 11

| | | | | C9 | | | | | |
|---|---|---|---|---|---|---|---|---|---|
| | TMP | THEIC | mHHPA | Acid | | | | Mark | Intrinsic |
| Example | (Moles) | (Moles) | (Moles) | (Moles) | Mn | Mw | Mz | Houwink | Viscosity |
| Example 28 | 4 | 0 | 3 | 2 | 1580 | 3224 | 6700 | 0.28 | 4.14 |
| Example 29 | 3 | 1 | 3 | 2 | 1220 | 2950 | 6064 | 0.25 | 3.78 |
| Example 30 | 2 | 2 | 3 | 2 | 1351 | 2650 | 5206 | 0.26 | 3.65 |
| Example 31 | 1 | 3 | 3 | 2 | 1082 | 22286 | 4334 | 0.23 | 3.47 |
| Example 32 | 0 | 4 | 3 | 2 | 1170 | 2457 | 4925 | 0.23 | 3.45 |

TABLE 12

| | % | Visco | König | | | | | | | |
|---|---|---|---|---|---|---|---|---|---|---|
| Example | TS | (cps) | (s) | du | Wa | Wb | Wc | Wd | We | DOI |
| Example | 60 | 31 | 176 | 2 | 3 | 5 | 7 | 5 | 6 | 96 |
| 28 | | | | | | | | | | |
| Example | 60 | 39 | 178 | 2 | 4 | 10 | 9 | 7 | 9 | 95 |
| 29 | | | | | | | | | | |
| Example | 60 | 47 | 163 | 2 | 5 | 11 | 9 | 7 | 9 | 95 |
| 30 | | | | | | | | | | |
| Example | 60 | 59 | 156 | 3 | 7 | 16 | 13 | 13 | 10 | 94 |
| 31 | | | | | | | | | | |
| Example | 60 | 61 | 156 | 3 | 7 | 18 | 17 | 12 | 9 | 94 |
| 32 | | | | | | | | | | |

Exchanging THEIC molewise for TMP only slightly changed the cured coating properties, indicating that, unlike with the dicarboxylic acid, varying the distance between the hydroxyl groups had little effect on curing properties.

### Examples 33-35

### Preparation of High Solids Pigmented Topcoat Formulations

Lau grind pigment pastes using a polyester were prepared. For each pigment paste, the components of Charge 1 were mixed along with 750 g of 1.2-1.7 ZIRCONOX milling media (available from Jyoti Ceramic Industries Pvt. Ltd. (Nashik, India)) and processed on a Lau disperser for 2 hours (4 hours for the MONARCH 1300). If needed, additional solvent (Charge 2) was used to adjust the final pigment paste viscosity.

### White (TiO₂) Pigment Paste

TABLE 13

| Charge | Component | Amount (g) |
|---|---|---|
| Charge 1 | Polyester 1 | 62.5 |
| | DISPERBYK | 3.85 |
| | 2155⁴ | |
| | TI-PURE R-900⁵ | 200 |
| | Butyl Acetate | 50 |

⁴Wetting and dispersing additive available from BYK-Chemie GmbH (Wesel, Germany)
⁵Titanium dioxide pigment available from The Chemours Company (Wilmington, DE)

The final white pigment paste had a solids content of 80% and pigment to binder ratio (P:B)=4.0

### Red Pigment Paste

TABLE 14

| Charge | Component | Amount (g) |
|---|---|---|
| Charge 1 | Polyester 1 | 62.5 |
| | DISPERBYK 2155⁴ | 7.5 |
| | Cinilex DPP Red BO⁶ | 150 |
| | Butyl Acetate | 127 |
| Charge 2 | Butyl Acetate (adjust) | 30 |

⁶Red pigment available from CINIC Chemicals Co., Ltd. (Shanghai, China)

The final red pigment paste had a solids content of 55% and P:B=3.0

### Black (Carbon Black) Pigment Paste

TABLE 15

| Charge | Component | Amount (g) |
|---|---|---|
| Charge 1 | Polyester 1 | 193 |
| | DISPERBYK 2155⁴ | 7.75 |
| | MONARCH 1300⁷ | 31 |
| | Butyl Acetate | 50 |
| Charge 2 | Butyl Acetate (adjust) | 40 |

⁷Carbon black available from Cabot Corporation (Boston, MA)

The final black pigment paste had a solids content of 60% and P:B=0.2

Pigmented Topcoat coating compositions were prepared according to Table 16. Amounts in Table 16 are in grams.

TABLE 16

| | Example 33 | Example 34 | Example 35 |
|---|---|---|---|
| Component | (White) | (Red) | (Black) |
| Pack A | | | |
| Polyester 1 | 14.9 | 13.6 | 12.6 |
| White Tint Paste | 19.4 | — | — |
| Red Tint Paste | — | 30.8 | — |
| Black Tint Paste | — | — | 10.2 |
| BYK 320¹ | 0.03 | 0.03 | 0.03 |
| BYK 306² | 0.13 | 0.13 | 0.13 |
| DBTDL | 0.03 | 0.03 | 0.03 |
| Butyl Acetate | 2.4 | 2.5 | 2.3 |
| Pack B | | | |
| DESMODUR N | 9.5 | 9.5 | 9.2 |
| 3400²⁹ | | | |
| Butyl Acetate | 3 | 1.2 | 2.1 |
| Coating | | | |
| Composition | | | |
| Properties | | | |
| Solids | 75 | 65 | 70 |
| Viscosity | 100 cps | 53 cps | 110 cps |
| P:B | 0.5 | 0.5 | 0.04 |

²⁹Aliphatic polyisocyanate (HDI uretdione) available from Covestro (Leverkusen, Germany)

The coating compositions in Table 16 were applied with a 6 mil drawdown bar over electrocoat panels (ED 6450 HIA test panel) and baked for 30 minutes at 80° C. Appearance was measured with the BYK Wavescan, and hardness was measured on the Konig pendulum device. Viscosity was measured with the CAP 2000 viscometer, and the data is reported in Table 17.

TABLE 17

| | % | Visco | König | | | | | | | |
|---|---|---|---|---|---|---|---|---|---|---|
| Coating | TS | (cps) | (s) | du | Wa | Wb | Wc | Wd | We | DOI |
| White | 75 | 100 | 143 | 6 | 3 | 4 | 3 | 2 | 3 | 94 |
| Coating | | | | | | | | | | |
| Composition | | | | | | | | | | |
| Red | 65 | 53 | 144 | 4 | 6 | 17 | 13 | 9 | 6 | 94 |
| Coating | | | | | | | | | | |
| Composition | | | | | | | | | | |
| Black | 70 | 110 | 139 | 1 | 3 | 6 | 5 | 4 | 6 | 96 |
| Coating | | | | | | | | | | |
| Composition | | | | | | | | | | |

Based on the results of Table 17, high solids, high hardness, and good appearance were achieved independent of pigmentation.

### Examples 36 and 37

### 1K Polyester Clearcoats

Two polyester clearcoats were prepared using the components provided in Table 18. Amounts in Table 18 are in grams.

TABLE 18

| | | Comparative |
|---|---|---|
| Components | Example 36 | Example 37 |
| Isopropyl Alcohol | 15 | 15 |
| Butyl Acetate | 16.7 | 16.7 |
| Polyester 1 | 89.74 | — |
| Comparative | — | 87.50 |
| Polyester 16 | | |
| RESIMENE CE- | 30 | 30 |
| 7103⁹ | | |
| BYK 320¹ | 0.12 | 0.12 |
| BYK 306² | 0.49 | 0.49 |
| DDBSA¹⁰ | 1.43 | 1.43 |
| Total | 138.48 | 136.23 |

⁹Melamine resin available from Cytec Industries Inc. (West Paterson, NJ)
¹⁰Dodecyl benzene sulfonic acid (DDBSA)-based catalyst available from Allnex (Frankfurt, Germany)

The clearcoats of Example 36 and Comparative Example 37 were spray applied onto solvent borne primed electrocoated panels (ED6060C test panels) in two coats with a 1 minute flash between coats. The clearcoats were flashed for 10 minutes at ambient conditions, then baked in an oven for 30 minutes at 80° C. The clearcoats had a dry film thickness of approximately 45-50 microns. The testing of properties for cure were performed initially at 1-hour post-bake and then followed up for hardness at 1 day and 5 days. Imprint testing utilized a square of bubble wrap approximately (2″×2″) placed on the cured panel on which a 250 g jar was placed for 24 hours. After removing the jar and wrap, the imprint markings were rated on a 0 to 5 scale with 0 being “no markings observed” and 5 being “severe imprint”. Hardness was measured utilizing the Koenig pendulum device. Results of these tests are shown in Table 19.

TABLE 19

| | | 1 hour | 24 hour | 5 day |
|---|---|---|---|---|
| Coating | Imprint | hardness | hardness | hardness |
| Example 36 | 0 | 145 | 159 | 151 |
| Comparative | 5 | 24 | 24 | 21 |
| Example 37 | | | | |

As shown in Table 19, the clearcoat prepared using the polyester of Example 36 showed better imprint and hardness characteristics compared to the clearcoat prepared using the polyester of Comparative Example 37.

### Examples 38 and 39

### Preparation of a Pre-Blend and Pigment Paste

A pre-blend (Example 38) and pigment paste (Example 39) were prepared for inclusion with basecoat compositions. The pre-blend and pigment paste were prepared using the components from Table 20. Amounts in Table 20 are in grams.

TABLE 20

Parts by weight of Component

| | Example 38 | Example 39 |
|---|---|---|
| Ingredient | (Pre-blend) | (Pigment Paste) |
| Butyl acetate | 40.00 | 20.00 |
| Isobutyl acetate | 30.00 | — |
| CHIGUARD 328 | 7.50 | — |
| solution¹¹ | | |
| Acrylic Polymer¹² | — | 66.67 |
| TCR3015A Aluminum | — | 15.79 |
| Paste¹³ | | |
| TCR3040 Aluminum | — | 4.30 |
| Paste¹⁴ | | |
| Sparkle Silver Ultra | — | 7.21 |
| 6605 Aluminum | | |
| Paste¹⁵ | | |
| Total | 77.50 | 113.97 |

¹¹20% solution of CHIGUARD 328 (UV stabilizer available from Chitec Technology Co., Ltd. (Shanghai, China)), in a blend of Xylene (6%) (available from Ashland Global Specialty Chemicals Inc. (Wilmington, DE)) and Butyl acetate (94%) (available from BASF (Ludwigshafen, Germany)
¹²Acrylic resin having an Mw of 8557 g/mol, a total solids of 68.4%, a calculated (Fox Equation) Tg of 30° C., and an OH value of 62.5
¹³Aluminum paste available from Toyal America, Inc. (Lockport, IL)
¹⁴Aluminum paste available from Toyal America, Inc. (Lockport, IL)
¹⁵Aluminum paste available from Silberline Manufacturing Co. Inc. (Tamaqua, PA)

### Examples 40-44

### Preparation of Basecoat Compositions

Basecoat compositions were prepared using the components from Table 21. Amounts in Table 21 are in grams.

TABLE 21

| | Parts by weight of Component | | | | |
|---|---|---|---|---|---|
| | Compar- | Compar- | | | |
| | ative | ative | | | |
| | Exam- | Exam- | Exam- | Exam- | Exam- |
| Ingredient | ple 40 | ple 41 | ple 42 | ple 43 | ple 44 |
| Example 38 | 77.50 | 77.50 | 77.50 | 77.50 | 77.50 |
| (Pre-blend) | | | | | |
| Microgel¹⁶ | 30.00 | 30.00 | 30.00 | 30.00 | 30.00 |
| Acrylic¹⁷ | 46.44 | 46.44 | — | 23.22 | — |
| Polyester 8 | — | — | 42.86 | 21.43 | 42.86 |
| Example 39 | 113.97 | 113.97 | 113.97 | 113.97 | 113.97 |
| (Pigment Paste) | | | | | |
| CYMEL 1158¹⁹ | 25.64 | — | 25.64 | 25.64 | — |
| RESIMENE | — | 20.00 | — | — | 20.00 |
| CE-7103⁹ | | | | | |
| CAB solution²¹ | 40.00 | 40.00 | 40.00 | 40.00 | 40.00 |
| Ethanol | 10.00 | 10.00 | 10.00 | 10.00 | 10.00 |
| Phosphatized | 6.29 | 6.29 | 6.29 | 6.29 | 6.29 |
| Epoxy | | | | | |
| catalyst²² | | | | | |
| Phenyl acid | 1.33 | 1.33 | 1.33 | 1.33 | 1.33 |
| phosphate²³ | | | | | |
| Total | 351.77 | 345.53 | 347.59 | 349.38 | 341.95 |

¹⁶Rheology modifier having a solids content of 31%, a calculated Tg (Fox Equation) of 20° C., and an Mw of 1,000,000
¹⁷Acrylic resin having an Mw of 82,325 g/mol, a total solids of 65%, a calculated (Fox Equation) Tg of −24° C., and an OH value of 70.8
¹⁹Melamine available from Allnex (Frankfurt, Germany)
²¹25% solution of Cellulose Acetate Butyrate 551-02 (available from Eastman Chemical Company (Kingsport, TN)), in a blend of DOWANOL PM acetate (46.8%) (available from Dow Chemical Company (Midland, MI)), acetone (33.6%) (available from Dow Chemical Company (Midland, MI)), SOLVESSO 100 (7.9%) (available from Exxon Mobil Corporation (Irving, TX), and toluene (11.7%) (available from Ashland Global Specialty Chemicals Inc. (Wilmington, DE))
²²A solution of bisphenol A-epichlorohydrin resin available from Aditya Birla Chemicals (Mumbai, India) that has been phosphatized
²³Catalyst available from Islechem LLC (Grand Island, NY))

Solids content of the basecoat compositions was determined using an HG63 Moisture Analyzer available from Mettler Toledo run at 160° F. (71° C.). Solids content is listed in Table 22.

TABLE 22

| | Solids Content |
|---|---|
| Basecoat | (%) |
| Comparative | 29.9 |
| Example 40 | |
| Comparative | 31.8 |
| Example 41 | |
| Example 42 | 32.7 |
| Example 43 | 32.1 |
| Example 44 | 35.1 |

As indicated by Table 22, Examples 42 and 43, which included the polyester polyol according to the present disclosure, showed improved solids content compared to the coating of Comparative Example 40 prepared with the same melamine resin and without the polyester polyol according to the present disclosure. The coating prepared according to Example 44, which included the polyester polyol according to the present disclosure, had improved solids content compared to the coating of Comparative Example 41 prepared with the same melamine resin and without the polyester polyol according to the present disclosure.

The basecoat compositions were applied to Lyondell Basell Hifax TRC779X (4″×12″×0.118″) thermoplastic olefin (TPO) panels (available from Standard Plaque Inc. (Melvindale, MI)). For the basecoat compositions, CMPP3700A adhesion promoter and TKU2000CS 2K isocyanate clearcoat, both available from PPG Industries Inc. (Pittsburgh, PA), were used to make coated test panels. The adhesion promoter was applied via automated spray applied targeting a dry film thicknesses of 5-10 microns. The adhesion promoter was allowed to flash untimed in a horizontal position at ambient conditions up to 24 hours. The basecoat and clearcoat were applied wet-on-wet via automated spray applied targeting a dry film thicknesses of 15-23 and 43-48 microns, respectively. The basecoat was applied in 2 coats with 60 second ambient flash between coats and at least a 4 ambient minute flash before clearcoat application. The clearcoat was sprayed in 2 coats with a 60 second ambient flash between coats and at least a 10 minute ambient flash before entering the cure oven. The system was baked to achieve a part temperature of 180° F. (82° C.) for 25 minutes in a vertical position.

The coated panels were tested for hardness using the Koenig pendulum device. Panels were tested 1 hour and 7 days after cure. Results can be found in Table 23.

TABLE 23

BYK Pendulum Hardness (seconds)

| Basecoat | 1 Hour | 7 days |
|---|---|---|
| Comparative | 45 | 60 |
| Example 40 | | |
| Comparative | 39 | 52 |
| Example 41 | | |
| Example 42 | 48 | 74 |
| Example 43 | 44 | 66 |
| Example 44 | 39 | 58 |

As can be seen in Tables 23-26 the coatings prepared according to Examples 42 and 43 had improved hardness at 7 days without detriment to fuel resistance or appearance compared to the coating of Comparative Example 40 prepared with the same melamine resin and without the polyester polyol according to the present disclosure. The coating prepared according to Example 44 had improved hardness at 7 days without detriment to fuel resistance or appearance compared to the coating of Comparative Example 41 prepared with the same melamine resin and without the polyester polyol according to the present disclosure.

The coated panels were tested for resistance to delamination in a fuel soak test after being allowed to rest for 7 days. The coated panels were cut into three 1″×4″ pieces for each coating system to be tested for fuel resistance. Cut edges were covered using Nichiban LP-24 tape available from Alliance Rubber Company (Hot Springs, AR). An “X” was cut into the coating layers on one end of each panel and that end was submersed in a synthetic fuel (formulation in Table 24). The panels were timed from the time they were submerged in the fuel until the time the coating started to lift from the “X”. The time at which the coating lifted from the substrate was recorded as the time to fail. The times to fail for the three panels for each coating system were averaged, rounded to the nearest whole value and listed as Fuel Resistance. Results are shown in Table 25.

TABLE 24

| | Parts by weight of |
|---|---|
| Component | Component |
| 2,2,4-trimethylpentane | 25.35 |
| Toluene | 42.25 |
| di-isobutylene | 12.68 |
| Ethanol SDA-3A 200 | 4.22 |
| PROOF | |
| Formic Acid | 0.002 |
| Methanol | 15.00 |
| Deionized water | 0.50 |
| Total | 100.002 |

TABLE 25

| | Fuel Resistance |
|---|---|
| Basecoat | (minutes) |
| Comparative | 13 |
| Example 40 | |
| Comparative | 10 |
| Example 41 | |
| Example 42 | 14 |
| Example 43 | 14 |
| Example 44 | 10 |

As can be seen in Table 25 the coatings prepared according to Examples 42 and 43 had improved or maintained a similar fuel resistance compared to the coating of Comparative Example 40 prepared with the same melamine resin and without the polyester polyol according to the present disclosure. The coating prepared according to Example 44 maintained a similar fuel resistance level compared to the coating of Comparative Example 41 prepared with the same melamine resin and without the polyester polyol according to the present disclosure.

Appearance of the basecoats was measured using the BYK Wavescan. Longwave (LW) and shortwave (SW) rates are reported in Table 26.

TABLE 26

WavescanDOI

| Basecoat | LW | SW |
|---|---|---|
| Comparative | 24.5 | 27.4 |
| Example 40 | | |
| Comparative | 24.6 | 27.7 |
| Example 41 | | |
| Example 42 | 19.1 | 28.9 |
| Example 43 | 20.1 | 23.5 |
| Example 44 | 20.0 | 26.7 |

The appearance data from Table 26 shows that the coatings of Examples 42-44 maintained a similar appearance, compared to their counterpart Comparative Examples 40 and 41, while maintaining or improving fuel resistance or solids content.

### Examples 45-48

### Preparation of Clearcoat Compositions Having a Blend of Polyester and Acrylic

Several clearcoat compositions were prepared using the components listed in Table 27. The coating compositions of Comparative Examples 45 and 46 included an acrylic resin without a polyester polyol according to the present disclosure. The coating compositions of Examples 47 and 48 included an acrylic resin blended with a polyester polyol according to the present disclosure. The acrylic resin in Examples 45-48 were secondary polyols prepared from identical monomer compositions; however, the acrylic resins of Comparative Example 45 and Example 47 were prepared in a batch process, while the acrylic resins of Comparative Example 46 and Example 48 were prepared in a continuous process. Amounts in Table 27 are in grams.

TABLE 27

| | Comparative | Comparative | Exam- | Exam- |
|---|---|---|---|---|
| Components | Example 45 | Example 46 | ple 47 | ple 48 |
| A Pack | | | | |
| Ethyl 3- | 19.67 | 19.67 | 19.67 | 19.67 |
| Ethoxypropionate | | | | |
| (EEP) | | | | |
| Methyl N-Amyl | 10.83 | 10.83 | 10.83 | 10.83 |
| Ketone (MAK) | | | | |
| DPMA glycol | 4.07 | 4.07 | 4.07 | 4.07 |
| ether | | | | |
| Acetone | 11.59 | 11.59 | 11.59 | 11.59 |
| CHIGUARD | 2.57 | 2.57 | 2.57 | 2.57 |
| 328²⁴ | | | | |
| TINUVIN 292²⁵ | 1.10 | 1.10 | 1.10 | 1.10 |
| Polyester 1 | — | — | 40.38 | 40.38 |
| Acrylic Polyol²⁷ | 117.56 | — | 56.25 | — |
| Acrylic Polyol²⁸ | — | 88.0 | — | 42.0 |
| BYK 320¹ | .08 | .08 | .08 | 08 |
| BYK 306² | .29 | .29 | .29 | .29 |
| DBTDL | 1.2 | 1.2 | 1.2 | 1.2 |
| B Pack | | | | |
| Isocyanate²⁹ | 49.85 | 49.85 | 54.25 | 54.25 |
| | 215.50 | 202.31 | 203.67 | 204.42 |

²⁴UV stabilizer available from Chitec Technology Co., Ltd. (Shanghai, China)
²⁵Hindered amine light stabilizer commercially available from BASF (Ludwigshafen, Germany)
²⁷Acrylic polyol described in US 2004/0234698 Example 4, Footnote 5. The acrylic polyol was prepared from a batch process and having a Tg of 22° C. and an Mn of 2900
²⁸Acrylic polyol described in US 2004/0234698 Example 4, Footnote 5. The acrylic polyol was prepared from a continuous process and having a Tg of 22° C. and an Mn of 2157
²⁹DESMODUR N 3300 (available from Covestro (Leverkusen, Germany)) in a solvent solution at 68% solids

The clearcoats were spray applied over primed electrocoated panels with a solventborne basecoat (ED6060C test panels), in two coats with a 1 minute flash between coats. The clearcoats were flashed for 10 minutes at ambient conditions, then baked in an oven for 30 minutes at 80° C. The clearcoats had a dry film thickness of approximately 35-40 microns. The testing of properties for cure were performed initially at 1-hour post-bake. Hardness was measured utilizing the Koenig pendulum device. Appearance was measured with a BYK Wavescan averaged over three scans. Results are shown in Table 28

TABLE 28

| | 1 hour | | |
|---|---|---|---|
| Coating | hardness | SW | LW |
| Comparative | 82 | 29.7 | 21.3 |
| Example 45 | | | |
| Comparative | 83 | 26.7 | 4.9 |
| Example 46 | | | |
| Example 47 | 76 | 17.5 | 4.2 |
| Example 48 | 76 | 12.2 | 1.9 |

As can be seen from Table 28, the appearance of the clearcoat compositions in Examples 47 and 48 improved compared to counterpart Comparative Examples 45 and 46, respectively, as indicted by the lower SW and LW values, without significantly affecting hardness of the coatings. An additional appearance improvement was realized by the use of an acrylic resin prepared using a continuous reactor process, compared to use of an acrylic prepared using a batch reactor process.

### Examples 49-50

### Preparation of Carbamoylated Polyester

Polyester polymer clearcoats were prepared by combining the components listed in Table 29. Amounts in Table 29 are in grams.

TABLE 29

| | Comparative | |
|---|---|---|
| Components | Example 49 | Example 50 |
| Methyl Amyl Ketone | 15.27 | 15.27 |
| EEP | 7.66 | 7.66 |
| Aromatic 100 Solvent | 2.87 | 2.87 |
| DPM Glycol Ether | 0.95 | 0.95 |
| EVERSORB 76³⁰ | 1.47 | 1.47 |
| EVERSORB 72³¹ | 1.48 | 1.48 |
| RESIMENE 757³² | 44.14 | 44.14 |
| Microgel³³ | 5.87 | 5.87 |
| Silica³⁴ | 25.84 | 25.84 |
| Acrylic³⁵ | 23.07 | 23.07 |
| Polyester³⁶ | 44.97 | — |
| Polyester³⁷ | — | 39.57 |
| DISPARLON OX- | 0.36 | 0.36 |
| 60³⁸ | | |
| TINUVIN 328³⁹ | 0.30 | 0.30 |
| EVERSORB 93⁴⁰ | 1.92 | 1.92 |
| Adhesion Promoter⁴¹ | 0.40 | 0.40 |
| Isobutyl Alcohol | 2.29 | 2.29 |
| Neutralized DDBSA | 3.63 | 3.63 |
| | 182.50 | 177.11 |

³⁰Additive available from Everlight Chemical Industrial Corp. (Taipei, Taiwan)
³¹Additive available from Everlight Chemical Industrial Corp. (Taipei, Taiwan)
³²Melamine resin available from Covestro (Leverkusen, Germany)
³³A rheological resin prepared as described in U.S. Pat. No. 4,540,740, Example 1
³⁴A mixture of 59.7% solvent, 7.7% AEROSIL R 812 from Evonik Industries (Essen, Germany), and 33.61% acrylic resin having an Mw of 8557 g/mol, total solids of 68%, a calculated (Fox Equation) Tg 4° C., and OH value of 116
³⁵An acrylic resin having an Mw of 9350 g/mol, a total solids of 67%, a calculated (Fox Equation) Tg of 10° C., and an OH value of 175
³⁶A polyester resin having an Mw of 2300 g/mol, a total solids of 66%, an OH value of 98.5, and an acid value of 7.3
³⁷A polyester polymer prepared as follows: 1800 g of Polyester 1 and 360 g of Aromatic 100 were added to a round bottom flask. The mixture was heated to 130° C. to remove the butyl acetate solvent. The mixture was cooled to 60° C. and 266.4 g of methyl carbamate was added. The mixture was heated to 140° C.-150° C. and held under total reflux for 1 hour. A short packed column with distillate temperature measuring ability was introduced. The mixture was kept at 145° C.-155° C. making sure the distillate temperature was <75° C. until the theoretical amount of methanol was collected (114 g). The mixture was held an additional 2 hours and then thinned with additional Aromatic 100 to 80% theory solids.
³⁸Additive available from King Industries (Norwalk, CT)
³⁹Additive available from BASF (Ludwigshafen, Germany)
⁴⁰Additive available from Everlight Chemical Industrial Corp. (Taipei, Taiwan)
⁴¹Adhesion promoting resin prepared from Examples A and B from U.S. Pat. No. 6,641,923 except utilizing SILRES SY 816 (Wacker Chemie AG (Munich, Germany)) as the starting siloxane

The example clearcoats were applied with a 6 mil. drawdown bar over an electrocoated steel panel (ED 6670). The clearcoats were flashed for 10 minutes at ambient conditions, then baked for 30 minutes at 140° C. and 80° C. The testing of cure properties was performed at 1-hour post-bake. Imprint testing utilized a (2″×2″) square of bubble wrap placed on the cured panel on which a 250 g jar was placed for 24 hours. After removing the jar and wrap, the imprint markings were rated on a 0 to 5 scale with 0 being “no markings observed” and 5 being “severe imprint” Hardness was measured utilizing the Koenig pendulum device. Table 30 shows the imprint and hardness results.

TABLE 30

| | | 24 Hour | 1 Hour |
|---|---|---|---|
| Coating | Bake | Imprint | Hardness |
| Comparative | 30′ @140° C. | 0 | 191 |
| Example 49 | | | |
| Example 50 | 30′ @140° C. | 0 | 192 |
| Comparative | 30′ @80° C. | 5 | 144 |
| Example 49 | | | |
| Example 50 | 30′ @80° C. | 0 | 198 |

The carbamoylated polyester had comparatively the same or better imprint and hardness results at both 80° C. and 140° C., and especially exhibited improved imprint and hardness at 80° C.

Whereas particular embodiments of this invention have been described above for purposes of illustration, it will be evident to those skilled in the art that numerous variations of the details of the present invention may be made without departing from the invention as defined in the appended claims.

1. A polyester polyol comprising a reaction product obtained from components comprising:
(i) a polyol comprising 3 or more hydroxyl groups;
(ii) a dicarboxylic acid or an anhydride thereof that comprises 3 carbon atoms or fewer between the carboxylic acid groups or the anhydride thereof;
(iii) a monocarboxylic acid or an anhydride thereof;
(iv) from 0 weight % to less than 10 weight % of a diol, based on total solids of the components included to obtain the reaction product; and
(v) from 0 weight % to less than 10 weight % of a dicarboxylic acid or an anhydride thereof that comprises greater than 3 carbons between the carboxylic acid groups or the anhydride thereof, based on total solids of the components included to obtain the reaction product;
wherein a molar ratio of (i)+(iv) to (ii)+(v) ranges from 1.08:1 to 1.75:1, such as 1.08:1 to 1.67:1, and a molar ratio of (i)+(iv) to (iii) ranges from 1.25:1 to 4:1, such as 1.3:1 to 2.5:1, and
wherein the reaction product comprises a hydroxyl value of from 60 to 300 mg KOH/g, such as 90 to 280 mg KOH/g, and an acid value of less than 15 mg KOH/g.

2. The polyester polyol of claim 1, wherein (i) the polyol comprises from 3 to 6 hydroxyl groups.

3. The polyester polyol of claim 1, wherein (i) the polyol has a number average molecular weight of less than 500 g/mol.

4. The polyester polyol of claim 1, wherein (ii) the dicarboxylic acid comprises cyclic content.

5. The polyester polyol of claim 1, wherein (iii) the monocarboxylic acid is aliphatic.

6. The polyester polyol of claim 1, wherein (iii) the monocarboxylic acid comprises 6 carbon atoms or more.

7. The polyester polyol of claim 1, wherein the components that form the reaction product are essentially free of a diol.

8. The polyester polyol of claim 1, wherein the reaction product comprises carbamate functionality.

9. The polyester polyol of claim 1, wherein the reaction product has a number average molecular weight of less than 7,500 g/mol, such as less than 5,000 g/mol.

10. The polyester polyol of claim 1, wherein the reaction product exhibits an intrinsic viscosity of up to 8 mL/g.

11. The polyester polyol of claim 1, wherein the reaction product comprises from 4 to 10 branching points and/or a polydispersity index (PDI) of up to 6.5.

12. The polyester polyol of claim 1, wherein the reaction product comprises from 3 to 8 hydroxyl groups per molecule.

13. A coating composition comprising: the polyester polyol of claim 1; and a crosslinker reactive with the polyester polyol.

14. The coating composition of claim 13, wherein the polyester polyol comprises at least 5%, such as from 5% to 45%, of the total hydroxyl equivalence in the coating composition.

15. The coating composition of claim 13, wherein the crosslinker comprises an isocyanate-functional compound, an aminoplast compound, an anhydride compound, a phenolic compound, or a combination thereof.

16. The coating composition of claim 13, further comprising a second hydroxyl functional polymer that is different from the polyester polyol.

17. (canceled)

18. The coating composition of claim 16, wherein a weight ratio of the polyester polyol to the second hydroxyl functional polymer is from 1:2 to 2:1.

19. The coating composition of claim 13, wherein the coating composition has a solids content of at least 50%.

20-23. (canceled)

24. A substrate at least partially coated with a coating formed from the coating composition of claim 13.

25-27. (canceled)

28. The substrate of claim 24, wherein the substrate comprises metal.

29-31. (canceled)
